(19) United States
(12) Patent Application Publication
(10) Pub. No.: US 2026/0230554 A1
(43) Pub. Date: Aug. 6, 2026

(54) ELECTRONIC APPARATUS AND METHOD OF PROVIDING PROGRESSIVE MODE TO USER

(71) Applicant: Seungman Kim, McLean, VA (US)

(72) Inventor: Seungman Kim, McLean, VA (US)

(21) Appl. No.: 19/043,433

(22) Filed: Feb. 1, 2025

(51) Int. Cl. H04M 1/72463; G06F 21/32; H04M 1/73

(52) U.S. Cl. CPC H04M 1/724634; G06F 21/32; H04M 1/73

(57) ABSTRACT

A mobile device includes a network unit to communicate with an external device, a sensor to sense a user, a panel to display one or more menus and to receive a user input, and a control unit to control the network unit, sensor, and panel to perform a function of the mobile device, to unlock the mobile device from a power saving mode to a normal mode according to a normal unlock method, and to unlock the mobile devices to a progressive mode between the power saving mode and the normal mode according to a progressive unlock method.

### BACKGROUND OF THE INVENTIVE CONCEPT

### 1. Field of the Inventive Concept

The present inventive concept relates to an electronic apparatus and method of providing a progressive mode to a user.

### 2. Description of the Related Art

A computing device has two modes to perform an unlock mode and a lock mode.

When a user needs a function of a mobile device, the user has to unlock the computing device to access a menu of the function of the mobile device.

### SUMMARY OF THE INVENTIVE CONCEPT

The present inventive concept provides an electronic apparatus to provide a progressive mode to a user.

The present inventive concept provides a method of providing a progressive mode to a user.

The present inventive concept provides a computer readable medium to contain computer readable codes as a program to execute a method of providing a progressive mode to a user.

Additional features and utilities of the present inventive concept will be set forth in part in the description, which follows and, in part, will be obvious from the description, or may be learned by practice of the present inventive concept.

The foregoing and/or other features and utilities of the present inventive concept may be achieved by providing a mobile device including a network unit to communicate with an external device, a sensor to sense a user, a panel to display one or more menus and to receive a user input, and a control unit to control the network unit, sensor, and panel to perform a function of the mobile device, to unlock the mobile device from a power saving mode to a normal mode according to a normal unlock method, and to unlock the mobile devices to a progressive mode between the power saving mode and the normal mode according to a progressive unlock method.

The control unit may change the mobile device from the normal mode to the power saving mode according to a normal lock method, and changes the mobile device from the normal mode to a regressive mode between the normal mode and the power saving mode according to a regressive lock method.

The progressive mode may include a plurality of sub-progressive modes having different numbers of the menus usable by the user.

The progressive mode may include a plurality of sub-progressive modes, and the progressive unlock method may include a plurality of sub-progressive unlock methods to correspond to the respective sub-progressive modes.

The progress unlock method may include a plurality of sub-progressive unlock methods which are lower versions of the normal unlock method.

The progress unlock method may be a lower version of the normal unlock method.

The control unit may perform an unlock method, change the mobile device to the normal mode when the unlock method corresponds to the normal unlock method, and change the mobile device to the progressive mode when the unlock method corresponds to the progress unlock method.

The control unit may perform the normal unlock method and the progressive unlock method, change the mobile device to the normal mode when the normal unlock method is successful, and change the mobile device to the progressive mode when the progressive unlock method is successful.

The control unit may perform the normal unlock method, changes the mobile device to the normal mode when the normal unlock method is successful, and change the mobile device to the progressive mode when the normal unlock method is not successful and when the progressive unlock method which is a lower version of the normal unlock method is successful.

The control unit may perform the normal unlock method in the power saving mode, and performs the progressive unlock method in the power saving mode and progressive mode.

The control unit may change the mobile device from the power saving mode to the normal mode according to the normal unlock method, and change the mobile device from the power saving mode to the progressive mode according to the progressive unlock method.

The control unit may change the mobile device from the power saving mode to the normal mode according to the normal unlock method, and the progressive mode according to the progressive unlock method.

The normal mode may include menus usable by the user, and the progressive mode may include a plurality of sub-progressive modes having different numbers of the menus usable by the user.

The normal mode may include menus usable by the user, and the progressive mode may include a plurality of sub-progressive modes each having a different number of the menus usable by the user.

The control unit may perform an unlock method in the progressive mode, change the mobile device to the normal mode when the unlock method matches the normal unlock mode, and change the mobile device between sub-progressive modes of the progressive mode when the unlock method matches sub-progressive methods of the progressive unlock method.

The control unit may control the panel to display a first setting menu to set the normal unlock method to correspond to the normal mode and a second setting menu to set the progressive unlock method to correspond to the progressive mode.

The control unit may change the mobile device to the normal mode according to the normal unlock method when the progressive mode is not set, and change the mobile device to the progressive mode according to the progressive unlock method when the progressive mode is set.

The normal unlock method may include biometric unlock methods and trusted unlock methods, and the progressive unlock method may include a lower version of the biometric unlock methods and trusted unlock methods.

The normal unlock method may include one of biometric unlock methods and trusted unlock methods, and the progressive unlock method may include the other one of the biometric unlock methods and trusted unlock methods.

The normal unlock method may include of biometric unlock methods and trusted unlock methods, and the progressive unlock method may include a plurality of sub-progressive unlock methods to respectively correspond to lower versions of the one of the biometric unlock methods and trusted unlock method.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a view illustrating a mobile device having a progressive mode according to an embodiment of the present inventive concept;

FIG. 2 is a block diagram illustrating a mobile device according to an embodiment of the present inventive concept;

FIG. 3 is a view illustrating a mobile device to select a progressive mode, a regressive mode, and an unlock mode according to an embodiment of the present inventive concept;

FIG. 4 is a view illustrating a progressive mode of a mobile device according to an embodiment of the present inventive concept;

FIG. 5 is a view illustrating a screen of a mobile device in a progressive mode according to an embodiment of the present inventive concept;

FIG. 6 is a view illustrating a method of setting a progressive mode according to an embodiment of the present inventive concept;

FIG. 7 is a flowchart illustrating a method of a mobile device to set a progressive mode according to an embodiment of the present inventive concept; and

FIG. 8 is a flowchart illustrating a method of a mobile device to perform a progressive mode according to an embodiment of the present inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

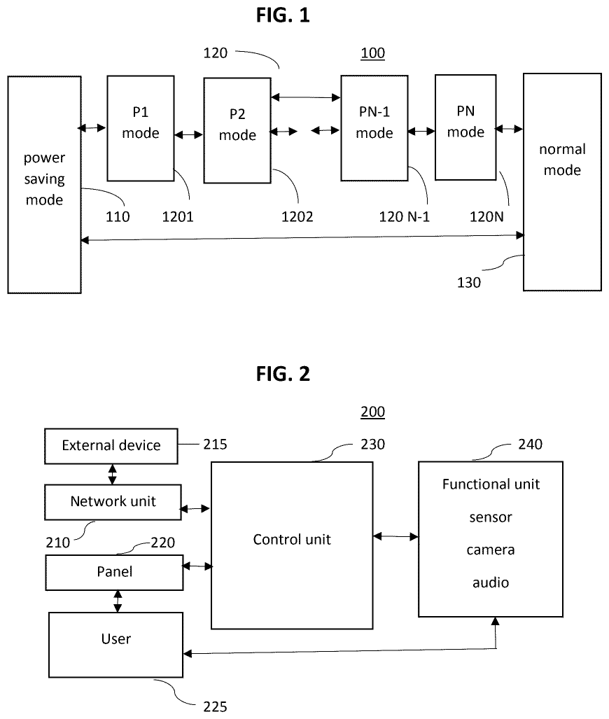

FIG. 1 is a view illustrating a mobile device 100 having a power saving mode 110, a progressive mode (or regressive mode) 120, and a normal mode 130 according to an embodiment of the present inventive concept.

The mobile device 100 may perform the power saving mode 100, the progressive mode (or regressive mode) 120, and the normal mode 130 according to corresponding unlocking methods of the mobile device 100.

The power saving mode 110 may correspond to a power off mode, an inactivating mode, a sleep mode, a panel-turned off mode, etc. The normal mode 130 may be an unlock mode, a power on mode, an activating mode, a panel-turned on mode, etc. The mobile device 100 may be unlocked from the power saving mode 110 to the normal mode 130 according to at least one of unlocking methods which include determining an authorized user (or user authentication). The authorized user may be determined through biometric unlock methods (face recognition, fingerprint, etc.) and trusted unlock methods (trusted place, trusted device, etc.) and a password method.

The reference number 120 may be referred to as the progressive mode or the regressive mode which is opposite to the progressive mode. The descriptions of the progressive mode may be referred to as the regressive mode in an opposite way. For example, the progressive mode is changed from P1 mode 1201 to P2 mode 1202 according to one of unlock methods while the regressive mode is changed from P2 mode 1202 to P1 mode 1201 according the one of unlock methods.

The progressive mode 120 may include a plurality of sub-progressive modes which may include P1 mode 1201, P2 mode 1202, . . . PN-1 mode 120N-1, and PN mode 120N. The number of the sub-progressive modes may be 1, 2, or more than 3. However, the present inventive concept is not limited thereto. The number of the sub-progressive modes may be set according to a user preference or a manufacturer preference. In the progressive mode 120, the mobile device 100 may be changed between the sub-progressive modes. The power saving mode 110 may be changed to the normal mode 130 or the P1 mode 1201 of the progressive mode 120. PN mode 120N may be changed to the normal mode 130. P2 mode 1202 may be changed to PN-1 mode or PN-1 mode 120N-1.

The regressive mode 120 may include a plurality of sub-regressive modes which may correspond to P1 mode 1201, P2 mode 1202, . . . PN-1 mode 120N-1, and PN mode 120N. In the regressive mode 120, the mobile device 100 may be changed between the sub-progressive modes. The normal mode 130 may be changed to the regressive mode 120 or the power saving mode 110. The normal mode 130 may be changed to PN mode 120N. PN mode 120N may be changed to PN-1 mode 120N-1. P1 mode 1201 may be changed to the power saving mode 110. The progressive unlock method may be usable as the regressive unlock method. The sub-progressive modes of the progressive mode may be referred to sub-regressive modes of the regressive mode. In the progressive mode, sub-progressive modes are changed to provide more menus usable by a user. In the regressive mode, the sub-progressive modes are changed to provide less menus usable by a user. Since the changing direction between the sub-progressive modes of the progressive mode is opposite in the regressive mode, it is possible that the regressive unlock method may be referred to a regressive lock method or a progressive lock method.

The mobile device 100 may be changed among the power saving mode 110, the progressive mode 120, and the normal mode 130 according to unlock methods which include a normal unlock method and a progressive unlock method.

The mobile device 100 may include a network unit to communicate with an external device, a sensor to sense a user, a panel to display one or more menus and to receive a user input, and a control unit to control the network unit, sensor, and panel to perform a function of the mobile device. The network unit, the sensor, and the panel receiving the user input may be usable as an unlock method including the normal unlock method, the progressive unlock method, and the regressive unlock method. The control unit may unlock the mobile device 10 from the power saving mode 110 to the normal mode 130 according to the normal unlock method, and unlock the mobile devices 100 to the progressive mode 120 between the power saving mode 110 and the normal mode 130 according to the progressive unlock method.

The mobile device 100 may be changed from the normal mode 130 to the power saving mode 110 according to a normal lock method, and from the normal mode 130 to the regressive mode 120 between the normal mode 130 and the power saving mode 110 according to a regressive lock method.

The normal mode 130 may include a plurality of menus usable by a user. The sub-progressive modes 120N may have different numbers of the menus usable by the user.

The progressive unlock method may include a plurality of sub-progressive unlock methods to correspond to the respective sub-progressive modes 1201 through 120N.

The progress unlock method may be a lower version of the normal unlock mode. The sub-progressive unlock methods may be lower versions of the normal unlock method.

The mobile device 100 may perform an unlock method during the power saving mode 110, may be changed to the normal mode 130 when the performed unlock method corresponds to the normal unlock method, and may be changed to the progressive mode 120 when the unlock method corresponds to the progress unlock method.

When detecting a face recognition is applied to the normal unlock method, the mobile device 100 may be unlocked to the normal mode when the face recognition is determined as an authorized user stored in a memory of the mobile device 100. It is possible that the mobile device 100 may be unlocked to the progressive mode 120, for example, the P1 mode 1201, when the face recognition is not determined as the authorized user but determined as 20% of the authorized user. When the face recognition is determined as 40% of the authorized user, the mobile device 100 may be changed to P2 mode 1202. When the face recognition is determined as 60% of the authorized user, the mobile device 100 may be changed to PN-1 mode 120N-1. When the face recognition is determined as 80% of the authorized user, the mobile device 100 may be changed to PN mode 120N. When the face recognition is determined as 100% of the authorized user, the mobile device 100 may be changed to the normal mode 130. Here, 20%, 40%, 60%, and 80% may be portions of a face of the face recognition. 20%, 40%, 60%, and 80% of the authorized user may be referred to as the progressive unlock method.

When detecting a fingerprint is applied to the normal unlock method, the mobile device 100 may be unlocked to the normal mode when the fingerprint is determined as an authorized user stored in a memory of the mobile device 100. It is possible that the mobile device 100 may be unlocked to the progressive mode 120, for example, the P1 mode 1201, when the fingerprint is not determined as the authorized user but determined as 20% of the authorized user. When the fingerprint is determined as 40% of the authorized user, the mobile device 100 may be changed to P2 mode 1202. When the fingerprint is determined as 60% of the authorized user, the mobile device 100 may be changed to PN-1 mode 120N-1. When the fingerprint is determined as 80% of the authorized user, the mobile device 100 may be changed to PN mode 120N. When the fingerprint is determined as 100% of the authorized user, the mobile device 100 may be changed to the normal mode 130. Here, 20%, 40%, 60%, and 80% may be portions of the fingerprint. 20%, 40%, 60%, and 80% of the authorized user may be referred to as the progressive unlock method.

When recognition of a trusted place is applied to the normal unlock method, the mobile device 100 may be unlocked to the normal mode when the trusted place is determined as an authorized user stored in a memory of the mobile device 100. It is possible that the mobile device 100 may be unlocked to the progressive mode 120, for example, the P1 mode 1201, when the trusted place is not determined as the authorized user but determined as 20% of the authorized user. When the trusted place is determined as 40% of the authorized user, the mobile device 100 may be changed to P2 mode 1202. When the trusted place is determined as 60% of the authorized user, the mobile device 100 may be changed to PN-1 mode 120N-1. When the trusted place is determined as 80% of the authorized user, the mobile device 100 may be changed to PN mode 120N. When the trusted place is determined as 100% of the authorized user, the mobile device 100 may be changed to the normal mode 130. Here, 20%, 40%, 60%, and 80% may be an accuracy of a location. 20%, 40%, 60%, and 80% of the authorized user may be referred to as the progressive unlock method.

When recognition of a trusted device is applied to the normal unlock method, the mobile device 100 may be unlocked to the normal mode when the trusted device is determined as an authorized user stored in a memory of the mobile device 100. It is possible that the mobile device 100 may be unlocked to the progressive mode 120, for example, the P1 mode 1201, when the trusted device is not determined as the authorized user but determined as 20% of the authorized user. When the trusted device is determined as 40% of the authorized user, the mobile device 100 may be changed to P2 mode 1202. When the trusted device is determined as 60% of the authorized user, the mobile device 100 may be changed to PN-1 mode 120N-1. When the trusted device is determined as 80% of the authorized user, the mobile device 100 may be changed to PN mode 120N. When the trusted device is determined as 100% of the authorized user, the mobile device 100 may be changed to the normal mode 130. Here, 20%, 40%, 60%, and 80% may be signal reception from the trusted device. 20%, 40%, 60%, and 80% of the authorized user may be referred to as the progressive unlock method.

When a user input, for example, a password, is applied to the normal unlock method, the mobile device 100 may be unlocked to the normal mode when the user input is determined as an authorized user stored in a memory of the mobile device 100. It is possible that the mobile device 100 may be unlocked to the progressive mode 120, for example, the P1 mode 1201, when the user input is not determined as the authorized user but determined as 20% of the authorized user. When the user input is determined as 40% of the authorized user, the mobile device 100 may be changed to P2 mode 1202. When the user input is determined as 60% of the authorized user, the mobile device 100 may be changed to PN-1 mode 120N-1. When the user input is determined as 80% of the authorized user, the mobile device 100 may be changed to PN mode 120N. When the user input is determined as 100% of the authorized user, the mobile device 100 may be changed to the normal mode 130. Here, 20%, 40%, 60%, and 80% of the authorized user may be referred to as the progressive unlock method.

The user input may be the normal unlock method, and the face recognition may be the progressive unlock method. The fingerprint may be the normal unlock method, and the face recognition may be the progressive unlock method. It is possible that the face recognition may be the normal unlock method, and a trusted unlock method, for example, the trusted place or the trusted device, may be the progressive unlock method. However, the present inventive concept is not limited thereto. Any combination of unlock methods can be usable as the normal unlock method and the progressive unlock method.

The mobile device 100 may simultaneously activate the normal unlock method and the progressive unlock method during the power saving mode 110. The mobile device 100 is changed to the normal mode 130 when the normal unlock method is successful, and is changed to the progressive mode 120 when the progressive unlock method is successful.

The mobile device 100 may activate or perform the normal unlock method, and may be changed to the normal mode 130 when the normal unlock method is successful, and may be changed to the progressive mode 120 when the normal unlock method is not successful and when the progressive unlock method which is a lower version of the normal unlock method is successful.

The normal unlock method may be performed in the power saving mode 110, and the progressive unlock method may be performed in the power saving mode 110 and/or the progressive mode 120.

The mobile device 100 may be changed from the power saving mode 110 to the normal mode 130 according to the normal unlock method, and may also be changed from the power saving mode 110 to the progressive mode 120 according to the progressive unlock method.

The mobile device 100 may be changed from the power saving mode 110 to the normal mode 130 according to the normal unlock method, and to the progressive mode 120 according to the progressive unlock method.

The normal mode may include menus usable by the user, and the progressive mode include a plurality of sub-progressive modes each having a different number of the menus usable by the user.

The normal mode 130 may include menus usable by the user, and the progressive mode may include a plurality of sub-progressive modes having different numbers of the menus usable by the user. For example, when the normal mode 130 includes 20 menus which are usable by the user, P1 mode 1201 may include 5 menus usable by the user, P2 mode 1202 may include 7 menus usable by the user, PN-1 mode 120N-1 may include 10 menus usable by the user, and PN mode 210N may include 15 menus usable by the user. In P1 mode 1201, 15 menus out of 20 menus may not be usable by the user.

When the user attempts to unlock the mobile device 100, the mobile device 100 may provide the user with the progressive mode 120 when a result of the unlock method is not sufficient (for example, 100% sufficient with or without a margin) to determine whether a user of the mobile device 100 is an authorized user. When the result of the unlock method is sufficient (for example, 100% sufficient with or without a margin) to determine that the user of the mobile device 100 is the authorized user, the mobile device 100 is changed to the normal mode 130. Depending on percentage (%) of the sufficiency of the result of the unlock method, the mobile device 100 may be changed to corresponding one of the sub-progressive modes 1201 through 120N.

When the mobile device 100 may perform an unlock method in the progressive mode, the mobile device 100 is changed to the normal mode when a result of the unlock method matches the normal unlock method, and is changed between sub-progressive modes 1201 through 120N of the progressive mode 120 when the result of the unlock method matches corresponding sub-progressive unlock methods of the progressive unlock method.

The mobile device 100 may control a panel to display a first setting menu to set the normal unlock method to correspond to the normal mode and a second setting menu to set the progressive unlock method to correspond to the progressive mode.

The mobile device 100 may be changed to the normal mode 130 according to the normal unlock method when the progressive mode is not set, and may be changed to the progressive mode 120 according to the progressive unlock method when the progressive mode is set.

The normal unlock method may include biometric unlock methods and trusted unlock methods, and the progressive unlock method may include one or more lower versions of the biometric unlock methods and trusted unlock methods.

The normal unlock method may include one of biometric unlock methods and trusted unlock methods, and the progressive unlock method may include the other one of the biometric unlock methods and trusted unlock methods.

The normal unlock method may include of biometric unlock methods and trusted unlock methods, and the progressive unlock method may include a plurality of sub-progressive unlock methods to respectively correspond to lower versions of the one of the biometric unlock methods and trusted unlock method.

The normal mode 130 may include a plurality of icon menus which include different levels of private icon menus and different levels of public icon menus. The private icon menus may be related to a user privacy, and the public icon menus may be not related to the user privacy. The user privacy may be defined according to a user preference or a maker preference. For example, the mobile device 100 may allow a user to select which menu or function is related to the user privacy. For example, bank menu icons may be related to a high level of the user privacy. It is possible that phone records may be related to a lower level of the user privacy. It is also possible that any menu using the biometric method to perform the menu function may be related to a middle level of the user privacy. It is also possible that a user may define any content to be related to a certain level of the user privacy, and in this case, any menu function including the user privacy content may be related to the same level of the user privacy.

Each of the sub-progressive modes 1201 through 120N may have a first number of private icon menus and a second number of public icon menus. For example, P1 mode 1201 may not have the private icon meus, and the user may not use the private icon menus. In this case, the first number of P1 mode 1201 may be zero.

The normal mode 130 may include all of the icon menus of the mobile device 100 which include one or more private icon menus and one or more non-privacy icon menus.

The progressive mode 120 may include one or more non-privacy icon menus (or public icon menus) which are not related to a user privacy. A user of the mobile device 100 may use the one or more non-privacy related menus in the progressive mode 120. The mobile device 100 may display the non-privacy related menus on a screen of a panel in the progressive mode 120. It is possible that the mobile device 100 may display all of the privacy related menus and the non-privacy related menus in the progressive mode 120. The privacy related menus may not be selectable or operable, or may be dimmed compared to the non-user privacy related menus when being displayed on the screen of the panel in the progressive mode 120. It is possible that the privacy related menus may not be displayed on the screen of the panel in the progressive mode 120. It is possible that P1 mode 1201 may have a number of non-user privacy icon menus according to a lowest level of a non-user privacy icon menu (or public icon menu), and PN mode 120N may have a number of non-user privacy icon menus according to a highest level of the non-user privacy icon menu (or public icon menu).

The progressive mode 120 may include one of more privacy icon menus according to a level of a user privacy. For example, P1 mode 1201 may include a number of privacy icon menus according to a lowest level of the user privacy. However, it is possible that P1 mode 1201 may not have any privacy icon menu. The number of privacy icon menus to be included in each of the sub-progressive modes 1201 through 120N may be determined according to a user's preference or a mobile device maker's preference.

The progressive unlock method may include sensing an event of the mobile device 100 to change the mobile device 100 to the progressive mode 120. The event may include a detection of a motion of the mobile device 100, a detection of an image, a detection of a sound, a detection of an external signal, a detection of any emergency condition of the mobile device 100 such as a car accident, shocking, or damage, and/or a detection of any environmental condition of the mobile device 100 such as light and audio characteristics. The event may include a partial result of one or more biometric unlock methods and/or a partial result of one or more trusted unlock methods. The event may be a partial input of a password. However, the present inventive concept is not limited thereto. The event may be defined by a user or a maker of the mobile device 100. The progressive unlock method may include progressively unlocking the mobile device 100 to a corresponding one of the sub-progressive modes 1201 through 120N between the power saving mode 110 and the normal mode 130 according to the event. The progressive unlock method may include a less degree of a result of a performed normal unlock method. For example, the normal unlock method may require a user input face to match about 100% (with or without a margin) of an authorized user face stored in a memory of the mobile device 100, and the event may include a less match, for example, a certain % match or a 50% match between the user input face and the authorized user face. For example, the normal unlock method may require a detection of an external device, and the progressive unlock method may include a less % detection of a signal from the external device, such as 35% or 50%, of the external device.

When a user is in a car accident situation, is unable to reach the mobile device 100, or is unable to perform the normal unlock method, the mobile device 100 may be progressively unlocked to one of sub-progressive modes 1201 through 120N by the event so that the user can use a menu to contact a person of a phone or message list or can access a social media through menus displayed on a screen of a panel of the mobile device 100 during the progressive mode 120. The event may be not limited to the above-described events. It is possible that any event to perform the progressive unlock method may be defined by a mobile device user preference or a mobile device maker preference.

When a user urgently needs to record a sound and/or image, the mobile device 100 may be progressively unlocked to one of sub-progressive modes 1201 through 120N to allow the user to record the sound and/or image in the progressive mode 120. It is possible that the mobile device may be progressively unlocked to automatically record the sound and/or image when a menu of the mobile device 100 is set to perform the recording according to the event without accessing the normal mode 130.

When a user is unable to reach the mobile device 100, the user may speak toward the mobile device 100. The mobile device 100 may be progressively unlocked to the progressive mode 120 according to a user voice as the event. The mobile device 100 may activate a unit or component to sense the event in the power saving mode 110 or the unlock mode 130 to perform the progressive unlock method according to the event. When a user is in a vehicle which is damaged, the mobile device 100 may receive a signal from the vehicle as the event to progressively unlock the mobile device 100 to the sub-progressive modes 1201 through 120N of the progressive mode 120 without accessing the normal mode 130.

When the normal unlock method is set to use a face recognition and when a user is in a position unable to be in front of a camera of a functional unit of the mobile device 100 to perform the normal unlock method of the face recognition to unlock the mobile device 100 to the normal mode 130, the mobile device 100 may be progressively unlocked to one of the sub-progressive modes 1201 through 120N according to the event such that the user may access a menu of the progressive mode 120 according to the event without accessing the normal mode 130. The user may also access a menu of the normal mode 130 according to the normal unlock method if necessary.

When the normal unlock method is set to use a fingerprint and when a user is unable to touch a sensor of a functional unit of the mobile device 100 to perform the normal unlock method of the fingerprint to unlock the mobile device 100 to the normal mode 130, the mobile device 100 may be progressively unlocked to the sub-progressive modes 1201 through 120N according to the event such that the user may access a menu of the progressive mode 120 according to the event and then may also access another menu according to the progressive unlock method or a level of a result of the normal unlock method without accessing the normal mode 130.

When a user wants to listen a music or video and when the user is unable to perform the normal unlock method, the mobile device 100 may be progressively unlocked according to the event to play the music or video in the progressive mode 120. When a user wants to access a public posting of a media, the mobile device 100 may allow the user to access the public posting in the progressive mode 120. When a user wants to publish a posting through a media, the mobile device 100 may allow the user to publish the posting in the progressive mode 120 without accessing the normal mode 130. However, the present inventive concept is not limited thereto. A user may be allowed to set one or menus to perform in the progressive mode 120.

The event may be referred to as a result of the performed progressive unlock method to change the mobile device 100 from the power saving mode 110 to the progressive mode 120, or to change the mobile device among the sub-progressive modes of the progressive mode 120.

It is possible that a first time condition is set to unlock the mobile device 1100 to the normal mode 130 according to the normal unlock method such as a password method or a non-password method. That is, the mobile device 100 is unlocked to the normal mode 130 according to the password when the mobile device is not in the first time condition, such 4 hours, or according to the non-password method when the mobile device is in the first time condition, such as 4 hours. However, the first time condition may be not applied to the progressive unlock method. It is possible that a second time condition is set to progressively unlock the mobile device 100 to the progressive mode 120. The second time condition may be 1 hour. It is also possible that a third time condition is set to sub-progressive modes 1201 through 120N. The first time condition may be longer than the second time condition. The second time condition may be longer than the third time condition. However, the present inventive concept is not limited thereto. It is possible that a time condition to P1 mode 1201 is 5 minutes, for example, and a time condition to PN mode 120N is 3 minutes.

It is possible that a fourth time condition, which is a time period or 2 hours, for example, may be set to maintain the progressive mode 120. That is, the mobile device 100 may maintain the progressive mode 120 within the time period and may be changed to the power saving mode 110 after the time period expires.

The first time condition may be set to be applied when the mobile device 100 is changed from the power saving mode 110 to the normal mode 130 according to the normal unlock method. The first time condition may not be applied when the mobile device 100 is changed from the power saving mode 110 to the progressive mode 120. However, the second time condition may be set to be applied when the mobile device 100 is changed from the power saving mode 110 to the progressive mode 120 or between P1 mode 1201 and PN mode 120N. The present inventive concept is not limited thereto. A user or a maker of the mobile device 100 may set a preference of when the first or second time condition is applied.

The progressive mode 120 may be maintained for a period which may be set by a user or a maker of the mobile device 100. The period may be extended according to repetition of the event for the progressive unlock method. When the period is set to one minute and the event is a user voice, the period is extended according to the user voice during the progressive mode 120. When the period is set to two minutes and the event is a motion of the mobile device 100, the period is extended according to the motion during the progressive mode 120. However, the period may not be extended to a second period which may be set by a user or a maker of the mobile device 100. The progressive unlock method may perform a voice command method to operate a menu of the progressive mode 120 according to a user voice instead of touching the menu.

The mobile device 100 may manually or automatically perform the normal unlock method during the progressive mode 120 to unlock to the normal mode 130 from the progressive mode 120.

The mobile device 100 may perform the normal unlock method to determine whether a user input or an event matches an authorized user of the mobile device 100. The mobile device 100 may be unlocked to the normal mode 130 when the user input or event matches the authorized user in the unlock method. However, it is possible that the user input or event may not be perfectly match or 100% match with the authorized user. In this case, the mobile device 100 may provide the progressive mode 120 to a user in response to the user input or event which is a lower version of the normal unlock method. Thereafter, the mobile device 100 may provide the normal mode 130 to the user according to a full version of the normal unlock method in the progressive mode 120.

When the normal unlock method includes a face recognition and an additional recognition such as eye opening or glasses, the mobile device 100 may be unlocked to the normal mode according to the normal unlock method of the face recognition and the additional recognition. It is possible that the mobile device 100 may provide the progressive mode 120 to the user in response to the face recognition without the additional recognition, and then may attempt to sense the face recognition and the additional recognition or the additional recognition to change the progressive mode 120 to the normal mode 130.

When the normal unlock method includes a face recognition to match an authorized user of the mobile device 100, the mobile device 100 may be unlocked to the normal mode 130 according to the face recognition. However, when the mobile device 100 is not able to change to the normal mode due to a missing portion of the face recognition. When the mobile device 100 does not receive a full portion of the face recognition, the mobile device 100 may change the power saving mode 100 to the progressive mode 120 or one of the sub-progressive modes 1201 through 120N according to corresponding levels of one or more recognized portions of a user face. Subsequently, the mobile device 100 may be changed to the normal mode 130 from the progressive mode 120 according to the full portion of the face recognition.

It is possible that the mobile device 100 requires a password to unlock to the normal mode 130 when the progressive unlock method and/or the normal unlock method fail in the power saving mode 110 or when the normal unlock method fails withing a time period. The mobile device may require the password to unlock to the normal mode 130 when the normal unlock method fails in the progressive mode 120 within a time period.

FIG. 2 is a block diagram illustrating a mobile device 200 according to an embodiment of the present inventive concept. The mobile device 200 may be an electronic terminal apparatus, a desktop computer, a computer apparatus, a laptop computer, a portable personal computer, a mobile electronic device, a mobile phone, a smartphone, a mobile tablet apparatus, a mobile tablet computing apparatus, an audio or video recording and/or reproducing apparatus, a photographing apparatus, a communication device, etc.

The mobile device 200 may include a network unit 210 to detect or communicate with an external device 215, a panel 220 to display a menu or an image on a screen and to receive a user input from a user 225, a control unit 210, and a functional unit including one or more sensors (or detectors), one or more cameras, and audio input/output unit such as microphone/speaker. The control unit controls all units of the mobile device 200.

The control unit 230 may include a data storage unit, a semiconductor memory unit, a central processing unit, a user interface unit, a graphic user interface unit, and a computer-readable medium containing computer-readable codes as a program to execute a method of the computing device 200. The control unit 210 may be connected to an external data storage unit through a port of the mobile device 200. A housing of the mobile device 200 may include the port such that another external data storage can be detachably attached to the port of the housing, and the port may be connected to the control unit 210 to transmit and receive data. It is possible that the mobile device 200 may be wirelessly connected to the external storage device.

The panel 200 may include a display panel to display the menu or image and a touch panel to receive the user input from the user 225. A password or fingerprint may be input through the panel as the normal unlock method to unlock the mobile device 200 to the normal mode 130 of FIG. 1. The camera may be operable as one of the sensors to photograph an object or a user to sense an event for a progressive unlock mode. The sensors (or detectors) may include a first sensor to sense the motion of the mobile device 200, a second sensor to sense an image or sound, a third sensor to sense the emergency condition, a fourth sensor to sense the environmental condition, a fifth sensor to sense a signal from an external device, and a sixth sensor to receive any event defined by a user of the mobile device 200.

The control unit 230 may perform the progressive unlock method of receiving the sensing results as the event and progressively unlocking the mobile device 200 to the progressive mode 120 of FIG. 1. The control unit 230 may perform the progressive unlock method including both the event and a less degree of the normal unlock methods to progressively unlock the mobile device 200 to the progressive mode 120 of FIG. 1.

The mobile device 200 may use the functional unit 240 and/or the network unit 210 to perform the normal unlock methods including biometric unlock methods and trusted unlock methods. The biometric unlock method may include biometric authentication, fingerprint, audio, voice, image, etc. The trusted unlock method may include a trusted location, a trusted device, etc. The mobile device 200 may use the functional unit 240, the panel 220, and/or the network unit 210 to perform the progressive unlock method. The progressive unlock method may use a less degree (or lower version) of the normal unlock methods. The progressive unlock method may use a less accuracy of the normal unlock method. The progressive unlock method may use an uncertainty of the normal unlock method. The progressive unlock method may use a less signal reception of a certain %, for example, 30%, 50% or 70% than a normal signal reception of the normal unlock method.

The progressive unlock method may be different from the normal unlock method. For example, when a face recognition is set as the normal unlock method of the mobile device 200, the progressive unlock method may use a less accuracy of the face recognition as the event compared to the accuracy of the face recognition of the progressive unlock method. It is possible that the progressive unlock method may use a portion of a user face as the event to perform the progressive unlock method. Since a camera of the mobile device 200 has a limited photographing angle to perform the normal unlock method, the mobile device 200 may use a portion of the user face to perform the progressive unlock method. It is possible that the progressive unlock method may use a blurred condition or a low resolution condition of a user face image as the event to perform the progressive unlock method since a camera of the mobile device 200 has a limited photographing distance to perform the unlock method.

When a face recognition is set as a normal unlock method of the mobile device 200, a detection of a signal of an external device may be set as the event of the progressive unlock method. When a face recognition is set as a normal unlock method of the mobile device 200, a detection of a motion of the mobile device 200 may be set as the event of the progressive unlock method. Regardless of the normal unlock method, the progressive unlock method may be set with detection of a motion of the mobile device 200 as the event. A predetermined motion of the mobile device 200 may be set as the event to perform the progressive unlock method. The predetermined motion may be different from a motion of the mobile device 200, in which the mobile device 200 is located in front of a user to perform the normal unlock method.

It is possible that the mobile device 200 may attempt to perform the normal unlock method and recognize an event from the normal unlock method and may perform the progressive unlock method according to the event to progressively unlock the mobile device 200 to the progressive mode. Thereafter, the mobile device 20 may attempt to perform the normal unlock method during the progressive mode to unlock the mobile device to the normal mode.

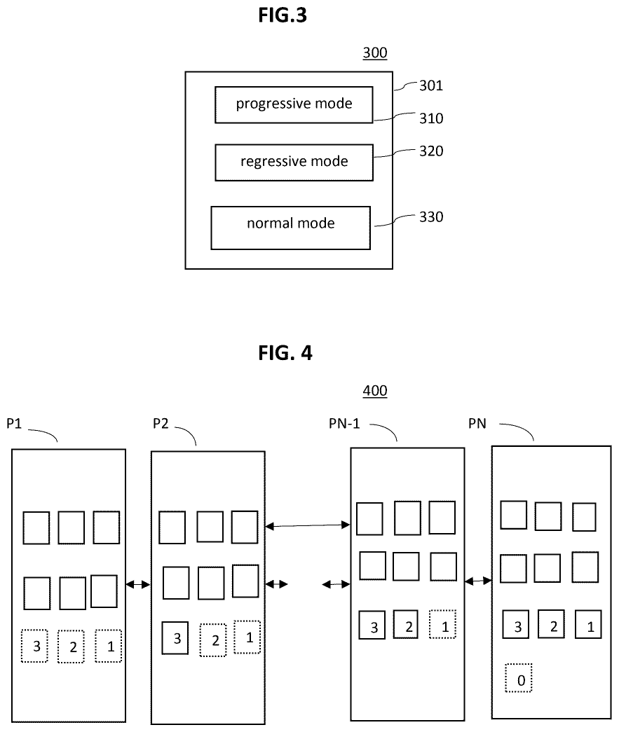

FIG. 3 is a view illustrating a mobile device 300 having a panel 301 with a screen to display a picture image, a photographing image, and/or one or menus to set a progressive mode setting menu 310, a regressive mode setting menu 320, and a normal mode setting menu 330 according to an embodiment of the present inventive concept.

A user may set a normal mode, a progressive mode, and a regressive mode through the progressive mode setting menu 310, the regressive mode setting menu 320, and the normal mode setting menu 330, respectively. When a user selects the progressive mode menu 310, the user may set the mobile device 300 with a progressive mode and a progressive unlock method. When a user selects the regressive mode menu 320, the user may set the mobile device 300 with a regressive mode and a regressive unlock method (or progressive lock method). When the user selects the normal mode menu 330, the user may set the mobile device 300 with a normal mode and a normal unlock method. It is possible that the progressive mode and the progressive unlock method may be set in the progressive mode setting menu 310 after the normal mode and the normal unlock method have been set in the normal mode setting menu 330. It is possible that the regressive mode and the regressive unlock method may be set in the regressive mode setting menu 320 after the normal mode and the normal unlock method have been set in the normal mode setting menu 330. It is possible that the regressive mode and the regressive unlock method may be automatically set after the progressive mode and the progressive unlock method has been set in the progressive mode setting menu 310 since a direction to change sub-progressive modes of the progressive mode is opposite to a direction to change sub-progressive modes of the regressive mode.

It is possible that a same time condition can be set together to correspond to the progressive unlock method, the regressive unlock method, and the normal unlock method. It is possible that an option of different time conditions can be set together with the progressive unlock method, the regressive unlock method, and the normal unlock method. A first time condition, for example, one minute, is applied to perform the progressive unlock method. If the progressive unlock method is not successful within the first time condition, the mobile device 300 may not be changed to the progressive mode but may continue the power saving mode. It is possible that a second time condition, for example, five minutes, is applied to change the progressive mode to the normal mode. If the normal unlock method fails within the second time period during the progressive mode, the mobile device 300 may be changed to the power saving mode from the progressive mode or may continue the progressive mode.

When the normal mode menu 330 is selected, the mobile device 300 may be set to perform the normal unlock method to unlock the mobile device 300 to the normal mode according to a password method or a non-password method. It is possible that when the user selects the normal mode menu 330, the panel 300 may display options of the normal mode menu 330, that is, setting the password method and the non-password method. When the user selects the option of the password method, the user may set a password to be stored in a memory of the mobile device 300. When the user selects the option of the non-password method, the user may set biometric unlock method and/or trusted unlock method, such as an authentication user, authorized user, a user face, a user fingerprint, a trusted place, a trusted device, etc., to be stored in the mobile device 300. It is possible that an option of the non-password method may be set together with a time condition. When the mobile device 300 is in the time condition, the option of the non-password method may be applied to perform the normal unlock method to unlock the mobile device 300 to the normal mode.

It is possible that a face unlock method may be set with a first unlock time condition, the fingerprint unlock method may be set with a second unlock time condition, the trusted place unlock method may be set with a third unlock time condition, and the trusted device unlock method may be set with a fourth unlock time condition.

When a user selects the progressive mode menu 310, the mobile device 300 may provide various options for a user to set the progressive unlock method as described above. When the user selects the normal mode menu 330, the mobile device 300 may provide various options for a user to set the normal unlock method as described above. It is possible that when a user selects the progressive mode menu 320, the mobile device 300 may provide options for a user to set the regressive unlock method as described above.

FIG. 4 is a view illustrating a progressive mode of a mobile device 400 according to an embodiment of the present inventive concept.

The progressive mode may include a plurality of sub-progressive modes P1, P2, . . . , PN-1, and PN each having different number of operable menus usable by a user. The mobile device 400 controls a panel with a screen to display each of the sub-progressive modes P1, P2, . . . , PN-1, and PN in response to the progressive unlock method. A first sub-progressive mode P1 may include a first number of the operable menus usable by a user. The first sub-progressive mode P1 may include non-operable menus 1, 2, and 3 which are unusable by the user. The operable menus may be displayed with solid lines, and the non-operable menus 1, 2, and 3 may be displayed with broken lines. A second sub-progressive mode P2 may include a second number of the operable menus usable by the user. The second sub-progressive mode P2 may include non-operable menus 1 and 2. In the second sub-progressive mode P2, the menu 3 is changed from a non-operable menu to a usable menu. The operable menus may be displayed with solid lines, and the non-operable menus 1 and 2 may be displayed with broken lines. An N-1th sub-progressive mode PN-1 may include a N-1th number of the operable menus usable by the user. The N-1th sub-progressive mode PN-1 may include non-operable menu 1. In the N-1th sub-progressive mode P2, the menu 3 is changed from a non-operable menu to a usable menu. The operable menus may be displayed with solid lines, and the non-operable menu 1 may be displayed with broken lines. An Nth sub-progressive mode PN may include a Nth number of the operable menus usable by the user. The Nth sub-progressive mode PN may include non-operable menu 0. In the Nth sub-progressive mode P2, the menu 1 is changed from a non-operable menu to a usable menu. The operable menus may be displayed with solid lines, and the non-operable menu 0 may be displayed with broken lines. It is possible that the non-operable menu 0, which was not shown in other sub-progressive modes, may be shown in the Nth sub-progressive mode PN. It is possible that the non-operable menu 0 of the Nth sub-progressive mode may be changed from a non-operable menu to an operable menu in the normal mode.

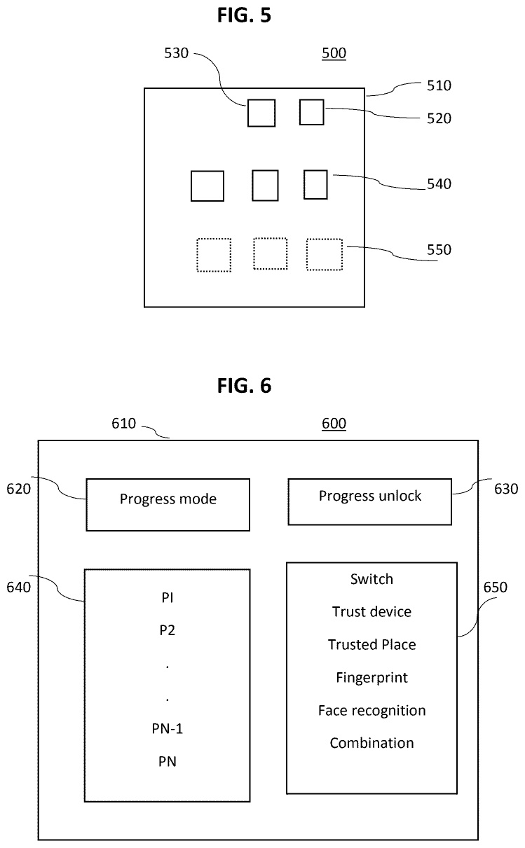

FIG. 5 is a view illustrating a screen 510 of a mobile device 500 in a progressive mode according to an embodiment of the present inventive concept. The mobile device 500 may control a panel with the screen 510 to display one or more menus 520, 530, 540, and 550. The menus 520 and 530 represent that the mobile device 500 is in the progressive mode and/or normal mode, respectively. The menu 520 may be a first symbols to indicate a progressive mode and the menu 530 may be a second symbol to indicate a normal mode. The menus 540 may be operable menus which can be usable by a user, and the menus 550 may be non-operable menus which cannot be usable by the user.

The first symbol 520 may represent a non-privacy privacy mode, and the second symbol 530 may a privacy mode. The menu 550 may include privacy mode menus and the menu 540 may include non-privacy mode menus.

The mobile device 500 may display the one or more non-privacy menus 540 on a first area of the screen 510 as a first group, and the one or more privacy menus 550 on a second area of the screen 510, in the progressive mode. It is possible that the one or more non-privacy menus 540 may be highlighted or toned compared to the one or more privacy menus, and/or the one or more privacy menus 550 may be dimmed compared to the one or more privacy menus. It is possible that the one or more non-privacy menus 540 may be defined by a solid line, and/or the one or more privacy menus 550 may be defined by a dotted line.

In the normal mode, the mobile device 500 may display all of the one or more privacy menus 550 and the one or more non-privacy menus 540 on the screen 510. The arrangement of the one or more privacy menus 550 and the one or more non-privacy menus 540 on the screen 510 in the normal mode may be different from the arrangement of the one or more privacy menus 550 and the one or more non-privacy menus 540 on the screen 510 in the progressive mode. It is possible that arrangements of menus in the progressive mode and the normal mode are same. It is possible that menus of the progressive mode and menus of the normal mode may be differently toned.

FIG. 6 is a view illustrating a method 600 of setting a progressive mode in a mobile device according to an embodiment of the present inventive concept.

The method 600 may include a setting menu screen 610 displayed on a panel of the mobile device. The setting menu screen 610 may include a progressive mode menu 620, a progressive unlock menu 630, a sub-progressive menu 640, and a progressive unlock method menu 650.

The method 600 may activate a progressive mode according to a selection of the progressive mode menu 620, and may activate a progressive unlock method according to a selection of the progressive unlock menu 630. The sub-progressive menu 640 may include a number of sub-progressive modes P1, P2, . . . , PN-1, and PN. The number of sub-progressive modes may be two or three. It is possible that the number of sub-progressive modes may be set by a user preference or a mobile device maker preference.

The progressive unlock method menu 650 may include a number of unlock methods. The unlock methods may have been set in the normal unlock method. The unlock methods may be performed as the normal unlock method to unlock the mobile device to the normal mode. When the unlock method is performed, the mobile device may be changed to the progressive mode or the normal mode according to a result of the performed unlock method. For example, when the result of the performed unlock method may be a full version of the unlock method, the mobile device determines that the result determines a perfect match with an authorized user of the mobile device, to unlock the mobile device to the normal mode. When the result of the performed unlock method may be a lower version of the unlock method, the mobile device determines that the result determines a not-perfect match with an authorized user of the mobile device and then the mobile device is changed to the progressive mode instead of the normal mode. Depending levels of the lower version of the unlock method, the mobile device is changed to one of the sub-progressive modes in the progressive mode.

The user may create a new unlock method to be added to the progressive unlock method menu 650. The user may remove one or more of the unlock methods from the progressive unlock method menu 650. The unlock methods of the progressive unlock method menu 650 may include a switch (or sensor), a trusted device, a trusted place, a fingerprint, a face recognition, and a combination of the switch (or sensor), the trusted device, the trusted place, the fingerprint, and the face recognition. It is possible that one of the unlock methods may be applied to all of the sub-progressive modes of the progressive mode. It is also possible that one of the unlock method may be applied to one of the sub-progressive modes and another one of the unlock methods may be applied to another one of the sub-progressive modes.

When the switch is set as the progressive unlock method, selection of the switch may progressively unlock the mobile device to one of the sub-progressive modes of the progressive mode. When the sensor is set as the progressive unlock method, sensing a user, for example, motions of the mobile device or motions/images of the user of the mobile device may progressively unlock the mobile device to one of the sub-progressive modes of the progressive mode.

When the trusted device is set as the progressive unlock method, a level of a signal reception from the trusted device may progressively unlock the mobile device to one of the sub-progressive modes of the progressive mode. When the trusted place is set as the progressive unlock method, levels of accuracy of a location or a distance from the location may progressively unlock the mobile device to one of the sub-progressive modes of the progressive mode. When the fingerprint is set as the progressive unlock method, different portions or accuracy of the fingerprint may progressively unlock the mobile device to one of the sub-progressive modes of the progressive mode. When the face recognition is set as the progressive unlock method, different resolutions, different portions, or different accuracies of a user face of the face recognition may progressively unlock the mobile device to one of the sub-progressive modes of the progressive mode. It is possible that a combination is set as the progressive unlock method. The combination may include two or more of the unlock methods. The two or more of the unlock methods may be sequentially or simultaneously performed to progressively unlock the mobile device to one of the sub-progressive modes of the progressive mode.

The method 600 may allow the user to connect the sub-progressive modes P1 through PN of the sub-progressive menu 640 and the unlock methods of the progressive unlock method menu 650. One of the unlock methods of the progressive unlock method menu 650 is dragged to the sub-progressive menu 640 to select the dragged unlock method as the progressive unlock method. One of the unlock methods of the progressive unlock method menu 650 is highlighted to the sub-progressive menu 640 to select the highlighted unlock method as the progressive unlock method. One of the unlock methods of the progressive unlock method menu 650 may be selected for a first number of the sub-progressive modes of the sub-progressive menu 640, and another one of the unlock methods of the progressive unlock method menu 650 may be selected as a second number of the sub-progressive modes of the progressive mode menu 640.

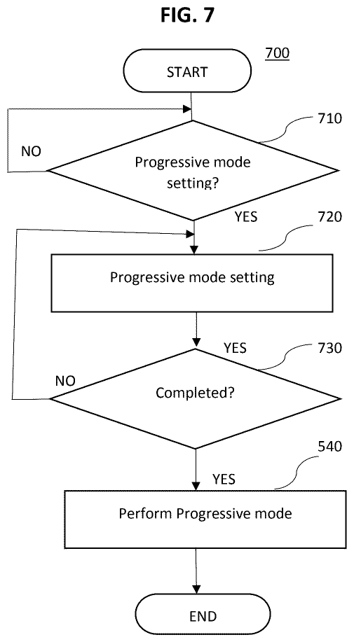

FIG. 7 is a flowchart illustrating a method 700 of a mobile device to set a progressive mode according to an embodiment of the present inventive concept.

At operation 710, it is determined that a progressive setting mode is selected. A progressive mode may be set in the progressive mode setting menu at operation 720. It is determined that setting the progressive mode is set at operation 730. The mobile device may perform the progressive mode according to a progressive unlock mode at operation 540.

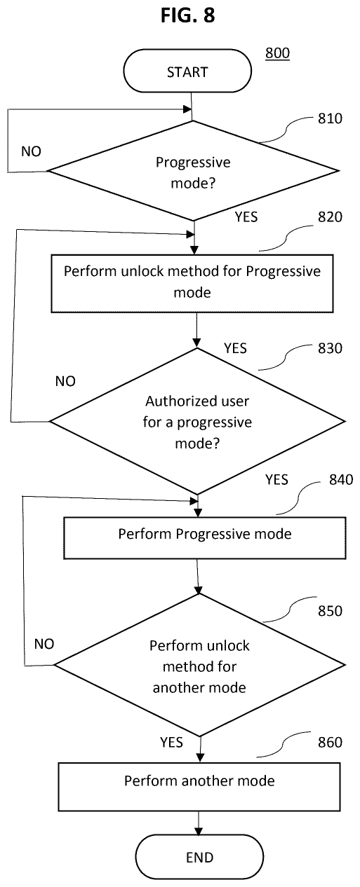

FIG. 8 is a flowchart illustrating a method 800 of a mobile device to perform a progressive mode according to an embodiment of the present inventive concept.

When the mobile device has been set to the progressive mode at operation 810, the progressive unlock method is performed at operation 820. It is determined whether an event as a result of the performed progressive unlock method is an authorized user of the mobile device at operation 830. The progressive mode is performed according to the event at operation 840. It is determined whether another event as another result of the unlock method is to change the mobile device to another mode at operation 850, and then the another mode is performed at operation 860. According to levels of the event at operation 830, the mobile device may perform one of sub-progressive modes of the progressive mode at operation 840. The another mode of operations 850 and 860 may be a normal mode or a power saving mode. It is possible that when a highest level of the event matches the normal unlock method, the mobile device may be changed from the progressive mode to the another mode, that is, the normal mode. It is possible that when the progressive unlock mode fails at operation 850, the mobile device may be changed to another mode, that is, the power saving mode.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a read-only memory (ROM), a random-access memory (RAM), a flash memory, a semiconductor chip package, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A mobile device comprising:
a network unit to communicate with an external device;
a sensor to sense a user;
a panel to display one or more menus and to receive a user input; and
a control unit to control the network unit, sensor, and panel to perform a function of the mobile device, to unlock the mobile device from a power saving mode to a normal mode according to a normal unlock method, and to progressively unlock the mobile device to a progressive mode having at least two sub-progressive modes between the power saving mode and the normal mode according to a progressive unlock method.

2. The mobile device of claim 1, wherein the control unit changes the mobile device from the normal mode to the power saving mode according to a normal lock method, and changes the mobile device from the normal mode to a regressive mode having at least two sub-regressive modes between the normal mode and the power saving mode according to a regressive lock method.

3. The mobile device of claim 1, wherein the at least two sub-progressive modes comprise different numbers of the menus usable by the user.

4. The mobile device of claim 1, wherein the progressive unlock method comprises a plurality of sub-progressive unlock methods to correspond to the respective sub-progressive modes.

5. The mobile device of claim 1, wherein the progress unlock method comprises a plurality of sub-progressive unlock methods which are lower versions of the normal unlock method.

6. The mobile device of claim 1, wherein the progress unlock method is a lower version of the normal unlock method.

7. The mobile device of claim 1, wherein the control unit performs an unlock method, changes the mobile device to the normal mode when the unlock method corresponds to the normal unlock method, and changes the mobile device to the progressive mode when the unlock method corresponds to the progress unlock method.

8. The mobile device of claim 1, wherein the control unit performs the normal unlock method and the progressive unlock method, changes the mobile device to the normal mode when the normal unlock method is successful, and changes the mobile device to the progressive mode when the progressive unlock method is successful.

9. The mobile device of claim 1, wherein the control unit performs the normal unlock method, changes the mobile device to the normal mode when the normal unlock method is successful, and changes the mobile device to the progressive mode when the normal unlock method is not successful and when the progressive unlock method which is a lower version of the normal unlock method is successful.

10. The mobile device of claim 1, wherein the control unit performs the normal unlock method in the power saving mode, and performs the progressive unlock method in the power saving mode and progressive mode.

11. The mobile device of claim 1, wherein the control unit changes the mobile device from the power saving mode to the normal mode according to the normal unlock method, and changes the mobile device from the power saving mode to the progressive mode according to the progressive unlock method.

12. The mobile device of claim 1, wherein the control unit changes the mobile device from the power saving mode to the normal mode according to the normal unlock method, and the progressive mode according to the progressive unlock method.

13. The mobile device of claim 1, wherein the normal mode comprises menus usable by the user, and the progressive mode comprises a plurality of sub-progressive modes having different numbers of the menus usable by the user.

14. The mobile device of claim 1, wherein the normal mode comprises menus usable by the user, and the progressive mode comprises a plurality of sub-progressive modes each having a different number of the menus usable by the user.

15. The mobile device of claim 1, wherein the control unit performs an unlock method in the progressive mode, changes the mobile device to the normal mode when the unlock method matches the normal unlock mode, and changes the mobile device between sub-progressive modes of the progressive mode when the unlock method matches sub-progressive methods of the progressive unlock method.

16. The mobile device of claim 1, wherein the control unit controls the panel to display a first setting menu to set the normal unlock method to correspond to the normal mode and a second setting menu to set the progressive unlock method to correspond to the progressive mode.

17. The mobile device of claim 1, wherein the control unit changes the mobile device to the normal mode according to the normal unlock method when the progressive mode is not set, and changes the mobile device to the progressive mode according to the progressive unlock method when the progressive mode is set.

18. The mobile device of claim 1, wherein the normal unlock method comprises biometric unlock methods and trusted unlock methods, and the progressive unlock method comprises a lower version of the biometric unlock methods and trusted unlock methods.

19. The mobile device of claim 1, wherein the normal unlock method comprises one of biometric unlock methods and trusted unlock methods, and the progressive unlock method comprises the other one of the biometric unlock methods and trusted unlock methods.

20. The mobile device of claim 1, wherein the normal unlock method comprises one of biometric unlock methods and trusted unlock methods, and the progressive unlock method comprises a plurality of sub-progressive unlock methods to respectively correspond to lower versions of the one of the biometric unlock methods and trusted unlock methods.
